(19) United States
(12) Patent Application Publication
(10) Pub. No.: US 2007/0083410 A1
(43) Pub. Date: Apr. 12, 2007

(54) Method of scheduling delivery of goods

(75) Inventor: Frederick William Hanna, Dublin (IE)

Correspondence Address: BIRCH STEWART KOLASCH & BIRCH, PO BOX 747, FALLS CHURCH, VA, 22040-0747, US

(73) Assignee: SWIFTXT LIMITED, Dublin (IE)

(21) Appl. No.: 10/571,994

(22) PCT Filed: Sep. 16, 2003
(86) PCT No.: PCT/IE03/00124

§ 371 Date: Sep. 6, 2006

(51) Int. Cl. G05B 19/418

(52) U.S. Cl. 705/8

(57) ABSTRACT

This invention relates to a method of scheduling delivery of goods from a Logistics Company Depot (LCD) (2) to a customer having a customer communications device (3) having an associated customer account and being capable of receiving and transmitting a text message in a system comprising a scheduling computer (4) having a scheduling memory and a communications network. The geographic location of the customer communications device (3) is determined at a predetermined initial time and depending on the distance between the customer communication device and the pre-agreed delivery drop off location, a further text message either canceling or confirming the delivery is sent. Dark house calls are avoided by predicting whether a customer is likely to be present at the agreed delivery time at the location.

This invention relates to a method of scheduling the delivery of goods from a Logistics Company Depot (LCD) to a customer having a customer communications device having an associated customer account and being capable of receiving and transmitting a text message in a system comprising a scheduling computer having a scheduling memory and a communications network including a network computer holding the customer account.

One of the main problems experienced by delivery companies is the expense incurred in the so-called “last mile delivery”, the delivery of goods from the delivery company depot to the customer's residence. In some cases the cost of “last mile delivery” exceeds 40% of total expenditure for the delivery company. One of the reasons why the last mile delivery represents such a disproportionate amount of the costs is the fact that usually more than one visit to a location has to be made before delivery of the goods can be achieved. It is estimated that these so-called “dark house” calls where the goods cannot be delivered due to the absence of the desired recipient are a major contributing factor to the overall cost of the last mile delivery. On average three delivery attempts are needed to secure delivery and logistics companies charges necessarily factor this in, resulting in inflated costs to the customer.

There have heretofore existed numerous ways in which the delivery companies have attempted to reduce costs. One such documented method is that of telephoning the customers to arrange a time for delivery. This solution has not been entirely successful as the customer is often not at home to receive the call and there is no guarantee that contact will be achieved before a delivery attempt is made. Another disadvantage of this method is that it is relatively expensive as manned call centres must be provided and large telephone charges can arise from lengthy discussions with customers.

Another solution to the problem has been the provision of secure access boxes such as those provided by Homeport®, Dynamid® and Brivo®. These secure access boxes are located outside the residence of a customer who gives the delivery company the access code so that the delivery company may access the box and leave the goods safely stowed inside. Various operational problems arise from this approach inter alia, the expense of the secure boxes, space limitations of the boxes render them inappropriate for larger packages and problems with communication of access codes to the logistics company.

Another proposed solution to the problem has been simply the back porch delivery approach where it is the practice of various delivery companies to make a number of attempts at delivery and if unsuccessful, to leave the package unattended for the recipient outside their address. This obviously raises various security and liability issues and is not seen as ideal.

Another major problem experienced by logistic companies is that a delivery time and place may be prearranged with the customer which the logistic company adheres to only to find that the customer is not at the prearranged delivery address at the allotted time. The delivery company is unable to determine the whereabouts of the customer who may be only a matter of minutes away and en route to the agreed delivery destination having been inadvertently delayed. Unable to wait indefinitely, the logistics company will normally continue with their remaining deliveries and attempt to deliver the goods at a future date. Furthermore, in many instances the customer may be delayed en route to the delivery destination to such an extent that they may be several hours late for the prearranged pick-up. In this instance the delivery company may wait outside the delivery destination for a significant time before abandoning the delivery attempt. This further increases the cost of delivery to the logistics company.

European Patent Specification number EP 0845747 (Hitachi) goes some way to overcoming these problems by providing a system in which the schedules of the customer and the delivery company may be compared before arranging a mutually agreeable delivery time. Both the recipient and the deliverer of the goods may cancel a particular delivery and attempt to arrange another delivery time. Further confirmation or cancellation of the delivery based on either the recipients or the delivery companies personnel is not possible however and as a result of which “dark house” calls may still be made.

Heretofore, none of the proposed methods of delivery of goods has been found to be sufficient. Therefore, it is an object of the present invention to provide a method of scheduling delivery of goods from a logistics company depot to a customer having a wireless communications device that is both efficient and cost effective to implement.

### STATEMENTS OF INVENTION

According to the invention there is provided a method of scheduling delivery of goods from a logistics company depot (LCD) to a customer having an associated customer account and a customer communications device capable of receiving and transmitting a text message in a system comprising a scheduling computer having scheduling memory and a communications network including a network computer holding the customer account, in which the method comprises the steps of:
(a) a delivery request being sent to the scheduling computer;
(b) the scheduling computer generating a text message according to the delivery request;
(c) transmitting the text message to the customer communications device requesting confirmation or otherwise of acceptance of proposed delivery at a designated delivery location;
(d) receiving a response to the text message from the customer communications device; and
(e) updating scheduling information for the LCD according to the response from the customer communications device and sending the scheduling information to the LCD and the customer communications device by a further confirmation text message giving delivery details including earliest estimated delivery time;
characterised in that
   at a pre-determined initial time, prior to the earliest estimated delivery time, the geographic location of the customer communications device is determined and depending on the distance between the customer communications device and the delivery location an initial delivery text message is sent, canceling or confirming the delivery.

By having such a method the number of dark house calls made by an LCD will be further reduced. By determining the geographic location of the customer communication device at a predetermined initial time, the method will be able to ascertain whether or not the customer is likely to be in a position to receive the goods for delivery. A further text message canceling or confirming the delivery is then made which will act as a further reminder to the customer that a delivery is scheduled. This method will significantly reduce the number of dark house calls made because the actual position of the customer may be determined at a predetermined initial time prior to delivery and the delivery can be either confirmed or cancelled on that basis.

In another embodiment of the invention there is provided a method in which when the text message is sent, the cancellation or confirmation of the delivery will be carried out at a predetermined future time, unless a text message from the customer communications device is received prior to that time to cause the decision regarding the delivery to be cancelled. In this way, the customer will be given an opportunity to overturn the delivery decision made by the scheduling computer. For instance, the customer may be a significant distance away but may still be able to make the predetermined time and destination for the delivery. In this instance, if the scheduling computer had cancelled the delivery the customer would have an opportunity to send a text message overturning the decision to cancel the delivery.

In one embodiment of the invention there is provided a method in which after the delivery has commenced and at a predetermined time prior to the estimated delivery time, a final delivery text message is sent to the customer communications device. This is seen as useful as a final reminder to the customer as they are made aware that the delivery service provided is en route and should they be delayed the customer is aware that the delivery is in process.

In a further embodiment of the invention there is provided a method in which, for the LCD, there is stored by the scheduling computer, delivery rules established by the LCD detailing the conditions under which the delivery will be handled. This is seen as useful as the LCD may specify the times and days in which it may make deliveries in a particular area and may update its rules according to its resources. This permits and supports the dynamic creation of new delivery schedules and rostas.

In another embodiment of the invention there is provided a method in which:
when the system includes a customer account associated with a customer and the method requires the payment of money, the customer communications device is sent a text message detailing the debiting or crediting required of the customer account;
the customer communications device sends a text message confirming permission to debit or credit the account with sufficient details to allow the action take place; and
the LCD carries out the necessary action in respect of the account.

In this way, prepayment of the delivery costs may be received from the customer prior to the delivery being made.

In one embodiment of the invention there is provided a method in which the customer communications device confirms the permission directly to the network computer. In this way the customer does not have to transmit any of its details to the LCD but may carry out payment through an intermediary network computer.

In a further embodiment of the invention there is provided a method in which when, prior to delivery, the customer communications device sends a text message to the scheduling computer altering the proposed delivery details, the scheduling computer cancels the delivery and carries out the method as if it were a new delivery. This is seen as particularly useful if the customer cannot make the predetermined delivery time and destination, a future delivery time can be agreed upon between the customer and the LCD simply by the customer sending an agreeable future time to the LCD. If the time is agreeable to the LCD further contacts and negotiation need not occur.

In another embodiment of the invention there is provided a method in which on the initial delivery text message being sent canceling the delivery, the method further comprises the step of the scheduling computer generating a further text message to reschedule the delivery. If it is determined that the customer will not be able to attend the scheduled delivery the scheduling computer automatically renegotiates a suitable delivery time for both parties.

In one embodiment of the invention there is provided a method in which the geographic location of a logistics company parcel service provider is monitored and depending on the distance between the parcel service provider and the delivery location an initial delivery text message is sent, canceling or confirming the delivery. In this way, the delivery can be confirmed or cancelled based on the geographic location of the LCD. If the LCD is too far away to make the delivery the customer and or the LCD can be sent a message canceling the delivery.

In a further embodiment there is provided a method in which on the logistics company determining that they cannot deliver the goods at the agreed time and location, the logistics company sends a reschedule request to the customer via the scheduling computer. If the LCD determines they cannot deliver the goods at the predetermined time a reschedule request may be sent by the LCD to the customer so that a new delivery time can be determined between the two. This is a simple and cost efficient method of rescheduling the delivery times.

In another embodiment of the invention there is provided a method in which on the geographic location of the customer communications device being determined a rescheduling request is sent to at least one of the customer communications device and the LCD. Having determined the geographic location of the customer a rescheduling request may be sent to the parties to reschedule the delivery of the goods to a future time.

In one embodiment of the invention there is provided a method in which the geographical location of both the customer communication device and the parcel service provider are monitored and on the distance between the customer communication device and the parcel service provider being below a predetermined distance a rescheduling request is sent to at least one of the customer communication device and the parcel service provider. This is seen as particularly useful as by monitoring the LCD and the customer communication device's positions the delivery may be made at an earlier time without causing the LCD to go to the predetermined address. For example, if both the LCD and the customer are en route to the delivery location and are in close proximity to each other an earlier delivery may be made by arranging a rendez vous in a place nearby to their current location.

In a further embodiment of the invention there is provided a method in which the geographic location of the customer communications device is determined using either GPS, the phone cell system or a combination of the GPS and phone cell system dependant on the geographic location of the customer communications device. These are seen as particularly reliable ways of determining the geographic location of the customer communication devices. Use of either GPS, the phone cell system or the combination of the GPS and phone cell system will be determined based on the geographic location of the customer. For example, in rural areas it may be desirable to use GPS whereas in urban areas the phone cell system may provide better accuracy or a cheaper alternative to using GPS.

In another embodiment of the invention there is provided a method in which the step of generating a text message according to the delivery request further comprises generating a short message service (SMS) text message. This is seen as a particularly cost efficient and effective way of generating a text message. Furthermore, it is seen as both simple and efficient to generate.

In one embodiment of the invention there is provided a method in which the step of receiving a response to the text message further comprises receiving an SMS text message from the customer communication device.

Alternatively, the step of generating a text message according to the delivery request could comprise generating an MMS message.

In a further embodiment of the invention there is provided a method in which the step of generating a text message according to the delivery request further comprises retrieving LCD scheduling information from the scheduling memory and generating the text message according to the scheduling information. In this way, care is taken not to overburden the LCD in any particular time slot in any particular day. By monitoring the scheduling information of the LCD and generating the text message according to the scheduling information the method ensures that it is possible for the LCD to make the delivery at that time.

In another embodiment of the invention there is provided a method in which the step of generating a text message according to the delivery request further comprises retrieving LCD profile data containing the suitable and available delivery times available to the LCD to make the delivery from the scheduling memory and generating the text message according to the profile data. In this way, only the delivery times that are suitable for the LCD are suggested to the customer.

In one embodiment of the invention there is provided a method in which the scheduling computer sends the scheduling information to the LCD at predetermined intervals. By sending the scheduling information to the LCD at predetermined intervals the LCD will have up to date delivery details at all times and will be able to plan deliveries of the goods to the recipients in advance.

In a further embodiment of the invention there is provided a method wherein the LCD requests the information from the scheduling computer when necessary. In this way the LCD can poll the scheduling computer as and when is necessary and may create its delivery schedules for a particular day or week in advance.

In another embodiment of the invention there is provided a method in which the scheduling computer stores a log of unsuccessfully sent text messages and re-sends those text messages after a predetermined time limit. By doing this the scheduling computer ensures that the text messages are received by the customers and a more reliable method is achieved.

In one embodiment of the invention there is provided a method in which the scheduling computer on receiving a response from the customer communication device that the proposed delivery times are unsuitable, the scheduling computer generates a further text message arranging the delivery of goods and sends the further text message to the customer communication device. In this way, if the suggested times are unsuitable further attempts are made to schedule delivery of goods with the customer. This will ensure that a better quality of service is provided to the LCD and the customer.

In a further embodiment of the invention there is provided a method in which subsequent to receiving the delivery request from the LCD the scheduling computer retrieves the contact details for the customers communication device from the LCD. This is seen as a simple and efficient way for the scheduling computer to retrieve contact details of the customers as the LCD should be in possession of the contact details in advance.

In another embodiment of the invention there is provided a method in which on receiving a customer communication device contact details, the scheduling computer stores the details in the scheduling memory for future use. In this way a database of customer details may be built up which will further speed up the method should further text messages have to be sent to the customer.

In one embodiment of the invention there is provided a method in which before retrieving the contact details from the LCD the scheduling computer attempts to retrieve the contact details from scheduling memory. In this way, the scheduling computer will poll its own memory to ascertain whether they have contact details for a customer prior to receiving the contact details from the LCD which will further speed up the method.

In a further embodiment of the invention there is provided a method in which the LCD sends a delivery request to the scheduling computer by sending a barcode to the scheduling computer. This is seen as a simple and efficient way of sending a delivery request to the scheduling computer.

In another embodiment of the invention there is provided a method in which on completion of a delivery the LCD accesses the scheduling information and updates the scheduling information. In this way, the scheduling information will be kept up to date.

In one embodiment of the invention there is provided a method in which the updated scheduling information is sent to the scheduling computer and the scheduling computer updates its scheduling information accordingly. In this way the scheduling computer will also have the most up to date scheduling information available.

In a further embodiment of the invention there is provided a method in which the LCD updates its profile data in the profiler in accordance with its resources. In this way, if the LCD should expand and obtain additional drivers or delivery vans the profile of the LCD may be updated accordingly which will allow it have more delivery slots available to customers. The scheduling computer can then offer these delivery slots to customers in the manner already described.

In another embodiment of the invention there is provided a method in which in sending the response to the delivery request text message the customer communication device sends a suggested delivery time and the scheduling computer checks the suggested delivery time for suitability before responding to the customer communications device. In this way, if none of the proposed delivery times are suitable to the customer communication device, the customer communication device user may suggest a delivery time that is suitable to them. This obviates the need for further negotiation of suitable times from the scheduling computer and the customer if this time is suitable to the LCD. If the time is suitable to both the LCD and the customer then the delivery can be agreed there and then.

In one embodiment of the invention there is provided a method in which on the customer suggesting a further delivery time and that delivery time being suitable, the scheduling computer updates the scheduling data.

In a further embodiment of the invention there is provided a method in which the method further comprises the steps of the scheduling computer generating a sub-optimal schedule for the logistics company depot and transmitting the sub-optimal schedule to the logistics company depot. The scheduling computer will generate the sub-optimal schedule for the logistics company depot based on all the scheduling information so that the LCD has an efficient (though possibly not optimal) schedule to work from.

In another embodiment of the invention there is provided a method in which the method further comprises the step of the scheduling computer generating a customised report for the LCD.

In one embodiment of the invention there is provided a method in which at a predetermined time the scheduling computer transmits billing data to a customer communications device's network operator. In this way, the customer may be billed directly to their mobile phone bill and will obviate the need to provide credit card details to a third party.

In a further embodiment of the invention there is provided a method in which the step of generating a text message according to a delivery request further comprises inserting LC specific graphical or textual content into the message.

In another embodiment of the invention there is provided a method of scheduling delivery of goods from a remote logistics company depot (LCD) to a customer having an associated customer account and a customer communications device being capable of receiving and transmitting a text message in a system comprising a remote scheduling computer having, scheduling memory and a communications network including a network computer holding the customer account, in which the method comprises the steps of:
(a) the customer communications device receiving a text message from the remote scheduling computer requesting confirmation or otherwise of acceptance of proposed delivery at a designated delivery location;
(b) transmitting a response to the text message from the customer communications device to the remote scheduling computer;
characterised in that:
(c) at a predetermined initial time prior to the earliest estimated delivery time, the customer communications device receives an initial delivery text message canceling or confirming the delivery, the content of the delivery text message being dependent on the relative position of the customer communications device to the designated delivery location.

This method provides the customer having a customer communications device with a reminder that the delivery is to be made and depending on whether the customer will be able to reach that delivery destination or not, that the delivery has been cancelled or confirmed.

In another embodiment of the invention there is provided a method in which a further delivery text message is received at a predetermined future time after the initial text message was received unless a text message is sent from the customer communications device to the remote scheduling computer prior to the predetermined future time to cause the decision regarding the delivery to be cancelled. This will allow the customer communication device user an opportunity to overturn the decision of the scheduling computer. This will be useful when the scheduling computer determines that the customer will not be able to make the delivery destination at the allotted time but the customer decides that they can indeed make the scheduled delivery destination. If however the user does not send a text message canceling the decision regarding the delivery, further rescheduling text messages may be sent to reschedule delivery.

In one embodiment of the invention there is provided a method in which after the delivery has commenced and at a predetermined time prior to the estimated delivery time, a final delivery text message is received by the customer communications device.

In a further embodiment of the invention there is provided a method in which the customer communications device receives a text message detailing the debiting or crediting required of a customer account, the customer communications device sends a text message confirming permission to debit or credit the account with sufficient details to allow the action to take place. This will allow billing of the customer communication device user's credit or debit card or indeed would allow for the billing to the user's mobile phone bill. The customer communication device may send the text message confirming permission to the remote LCD or alternatively may send the text message confirming permission directly to the network computer. By sending the details directly to the network computer the transmission of credit card details or debit card details to a third party is avoided.

In one embodiment of the invention there is provided a method in which having received a further delivery text message canceling the delivery, the customer communications device receives a further text message rescheduling delivery. By using this method the subsequent delivery of the goods can be rescheduled by the customer communication device and the scheduling computer.

In a further embodiment of the invention there is provided a method in which on the distance between the customer communications device and the parcel service provider being below a certain predetermined distance a rescheduling request is received by the customer communications device. In this way, if the customer and the LCD are within close proximity to each other the delivery may be rescheduled so that the delivery can take place earlier than expected. This could save the LCD having to return to an area that it is already in or having to go all the way to the destination address for the delivery.

In another embodiment of the invention there is provided a method of scheduling delivery of goods from a Logistics Company Depot (LCD) to a remote customer having an associated customer account and a customer communications device being capable of receiving and transmitting a text message in a system comprising a remote scheduling computer having scheduling memory and a communications network including a remote network computer holding the customer account in which the method comprises the steps of:
(a) transmitting a delivery request from the LCD to the remote scheduling computer;
(b) receiving scheduling information from the remote scheduling computer detailing a delivery to be made from the LCD including earliest estimated delivery time for that delivery;
   characterised in that:—
   at a predetermined initial time, prior to the earliest estimated delivery time, an initial delivery text message, either canceling or confirming the delivery dependent on the proximity of the remote customer communications device to the delivery location, is received by the LCD. This is seen as a particularly useful method as the LCD would be notified in advance before travelling to a customer's abode, that the customer will not be able to make the delivery time or that the customer will in all probability be at the pre-agreed delivery destination at the pre-arranged time.

In one embodiment of the invention there is provided a method in which on receipt of the initial delivery text message canceling the delivery the LCD sends a further delivery request to the remote scheduling computer. In this way, the LCD can reschedule the delivery of the goods with the minimum of difficulty.

In a further embodiment of the invention there is provided a method in which the method further comprises the initial step of the LCD establishing delivery rules detailing the conditions under which the delivery will be handled. In this way, the LCD can determine the conditions under which the deliveries may be handled that fit in with their resources such as vehicle and driver numbers as well as operating hours.

In another embodiment of the invention there is provided a method in which the LCD transmits a payment request to the remote customer communications device and thereafter the LCD receives payment information from the remote customer communications device and carries out the necessary action in respect of the account. In this way, the LCD can receive all payment details through the customer communication device and will not need further payment details to be provided and will not have the LCD personnel having to receive payment when making the delivery.

In another embodiment of the invention there is provided a method in which on the logistics company depot determining that they cannot deliver the goods at the agreed time and location, the logistics company depot sends a reschedule request to the remote customer communications device via the remote scheduling computer. This allows the logistics company to renegotiate a delivery time with the user in a simple and efficient manner.

In one embodiment of the invention there is provided a method in which on the distance between a LCD personnel and the customer communications device being below a predetermined distance, a rescheduling request is received by the LCD personnel. This allows the rescheduling of a delivery if the LCD personnel and the customer are within a predetermined distance from each other which can help the LCD reduce costs by delivering the goods at an earlier time than scheduled.

In another embodiment of the invention there is provided a method in which the distance between the LCD personnel and the delivery location is monitored and depending on the distance between the delivery location and the LCD personnel at that point in time, a text message is received by the LCD canceling or confirming delivery. If the LCD personnel are beyond a predetermined distance from the delivery location the delivery can be cancelled whereas if they are below a predetermined distance the delivery may be confirmed.

In another embodiment of the invention there is provided a method in which the method further comprise the step of the LCD receiving a sub-optimal schedule from the remote scheduling computer. This provides the LCD with a schedule from which they may carry out their deliveries in an ordered manner in the most efficient way possible based on the information available at that time.

In a further embodiment of the invention there is provided a computer program with program instructions for carrying out the method described. This computer program may be embodied on a storage medium such as a floppy disk or a CD ROM. It may be embodied on a carrier signal or embodied in an integrated circuit.

### DETAILED DESCRIPTION OF THE INVENTION

The invention will be more clearly understood from the following description of some embodiments thereof given by way of example only with reference to the accompanying drawings in which:—

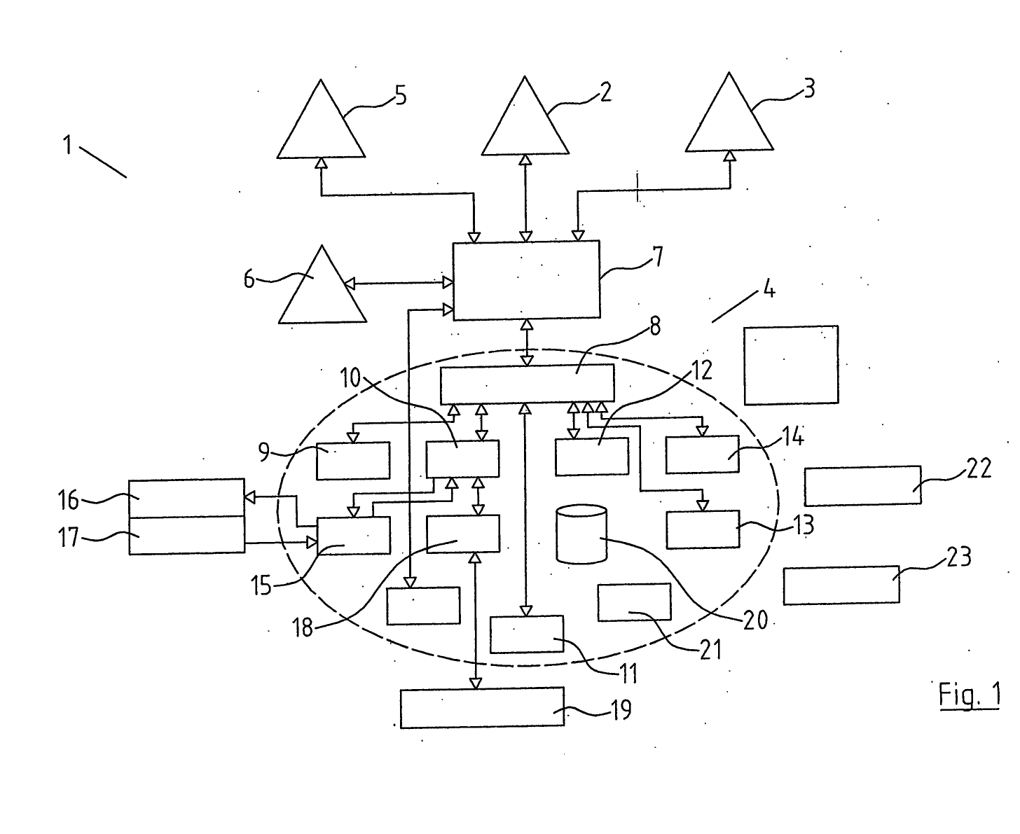

FIG. 1 is a block diagram of the system according to the invention;

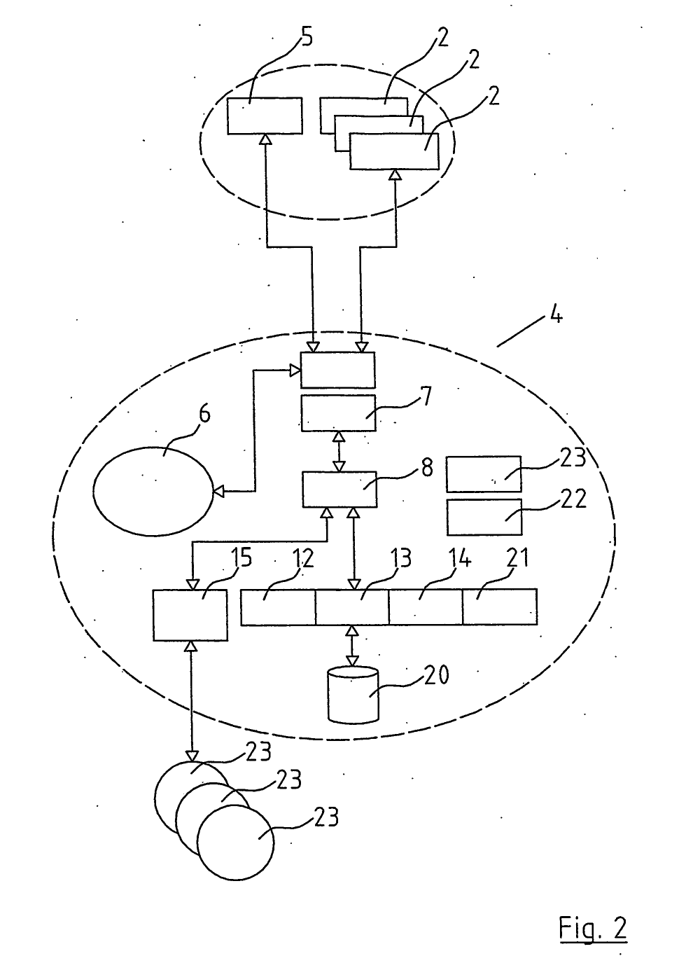

FIG. 2 is a further block diagram of the system according to the invention;

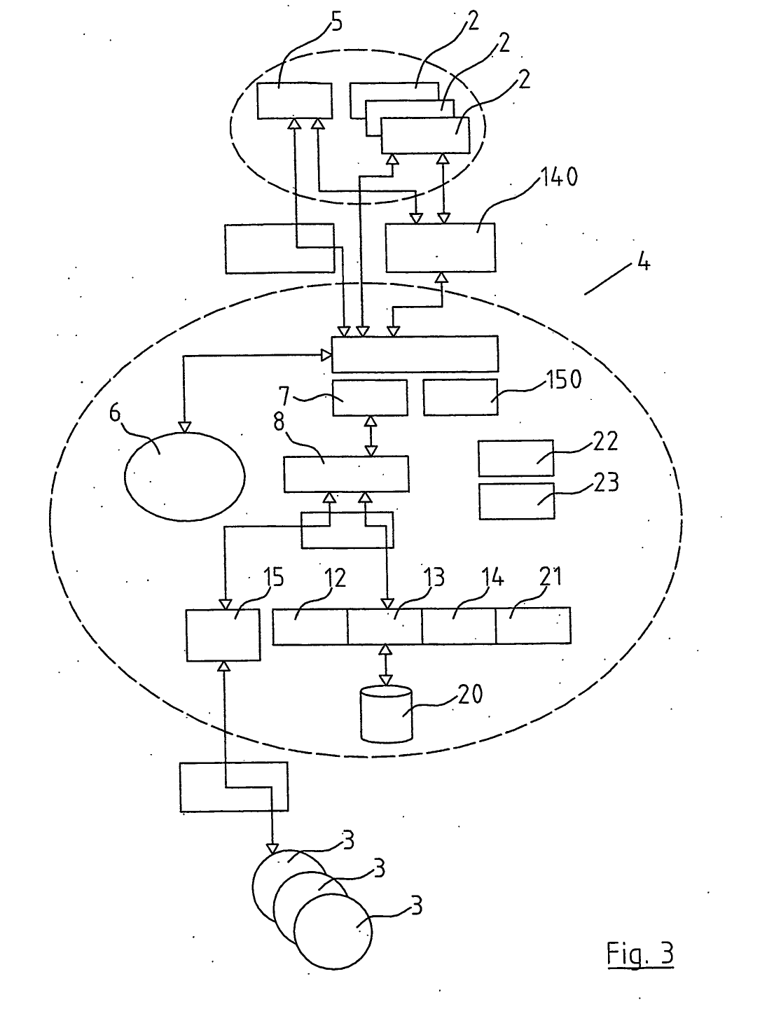

FIG. 3 is another block diagram of the system according to the invention;

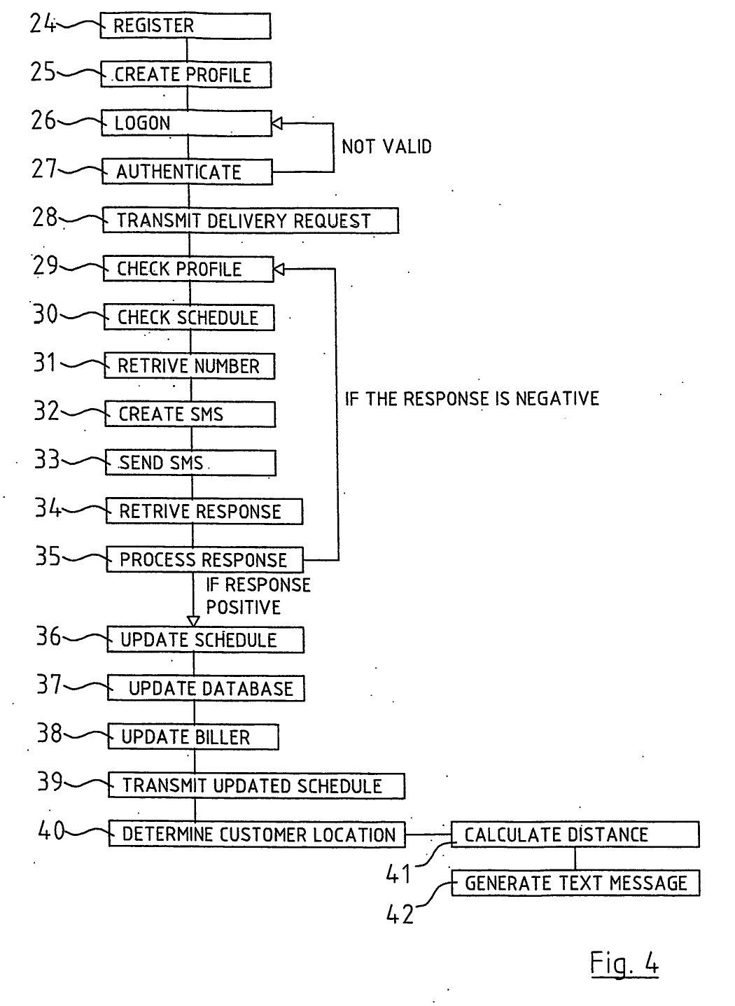

FIG. 4 is a flow diagram of the method according to the invention;

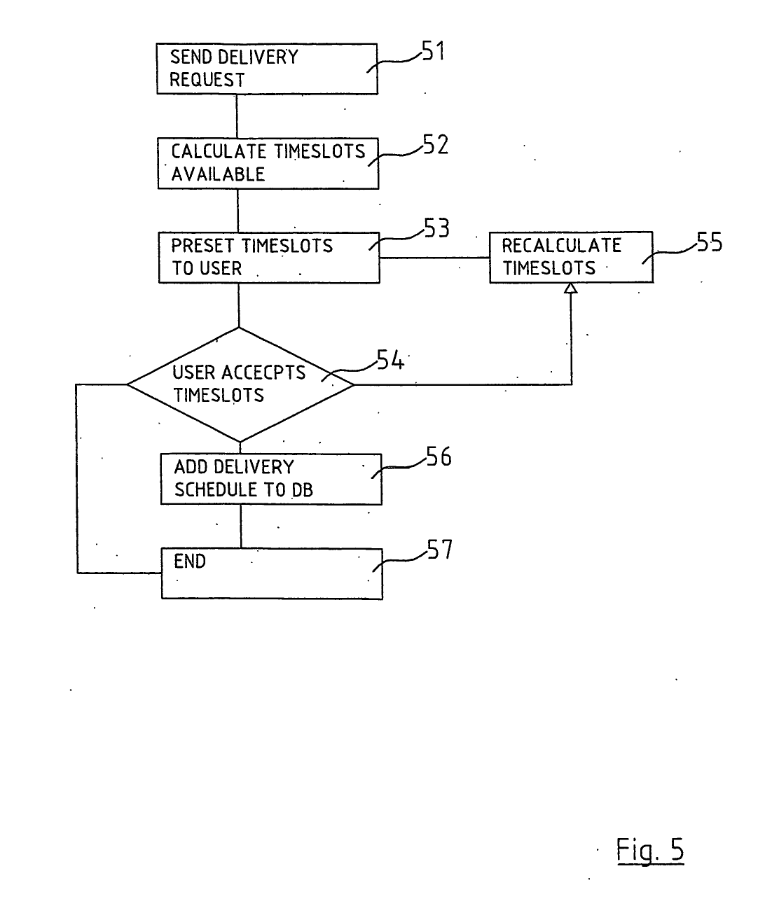

FIG. 5 is a flow diagram of the negotiation of a delivery between the scheduling computer and the customer communications device;

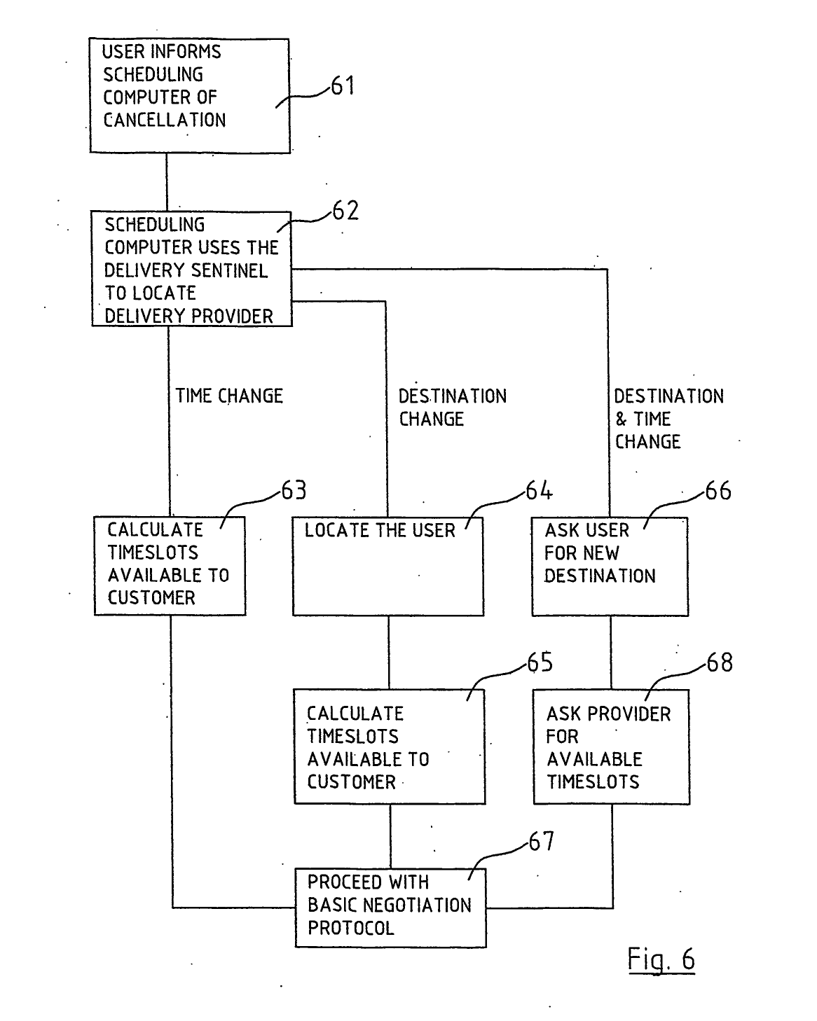

FIG. 6 is a flow diagram of the renegotiation of the delivery initiated by a customer communication device;

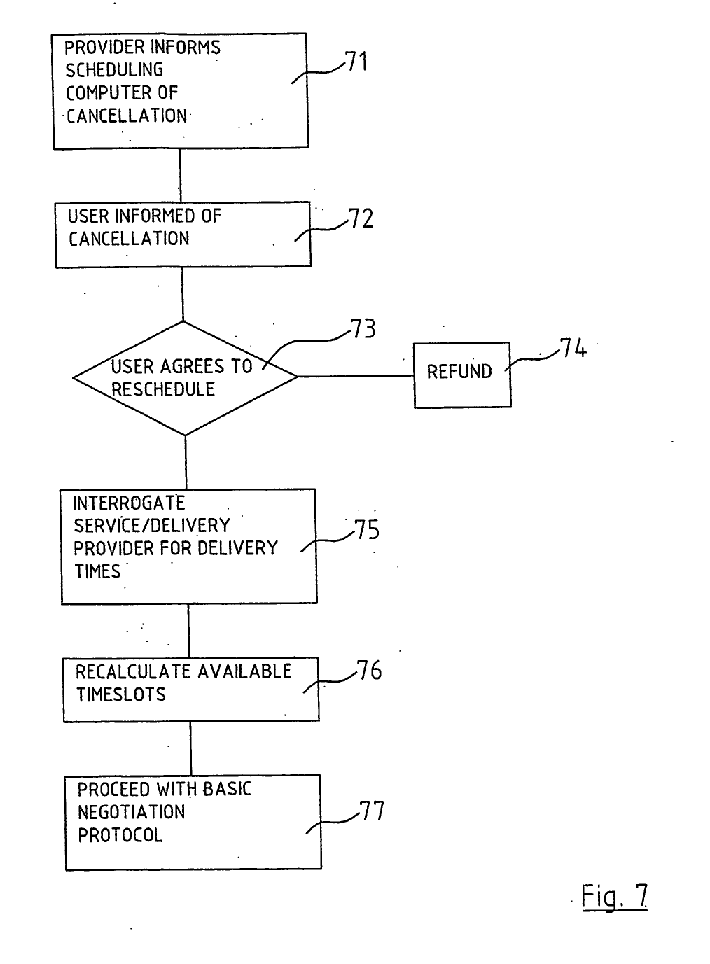

FIG. 7 is a flow diagram of the renegotiation of the delivery initiated by the LCD;

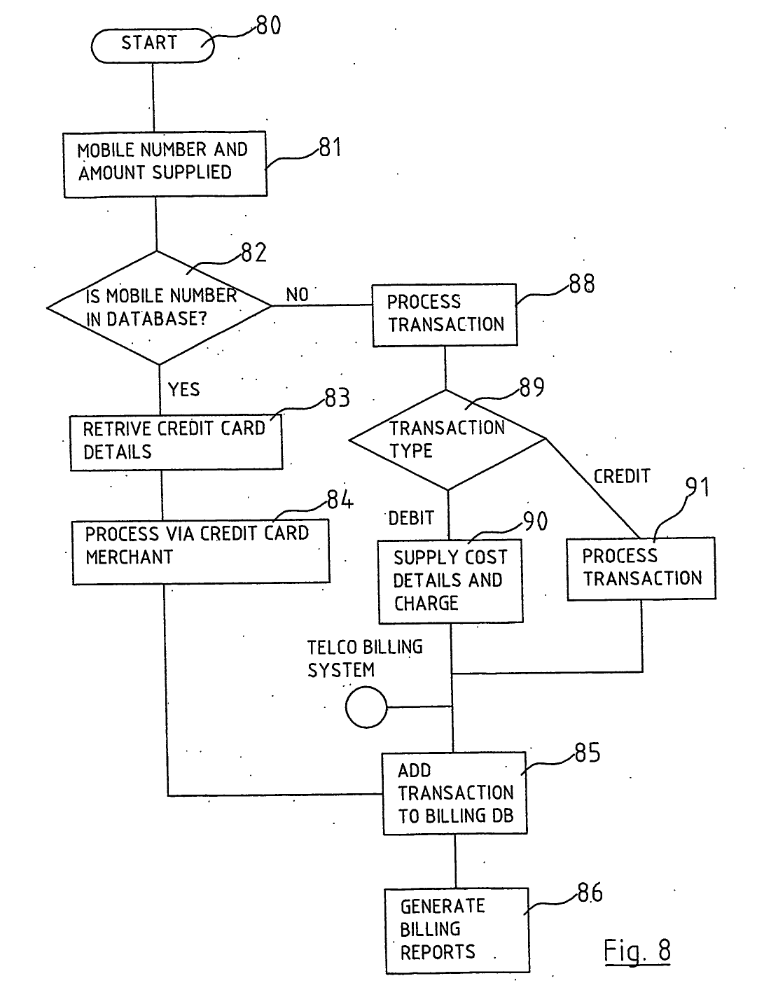

FIG. 8 is flow diagram of the billing agent in operation;

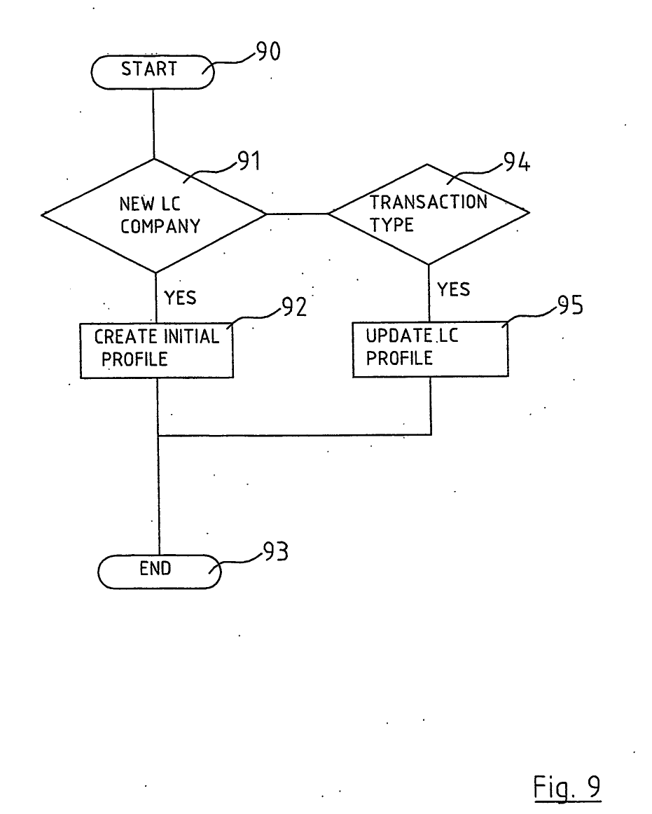

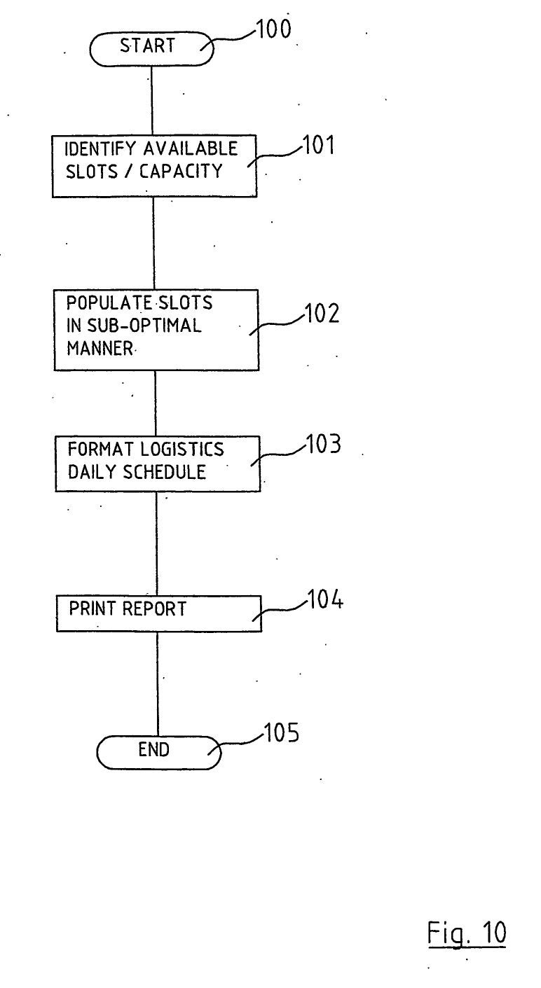

FIG. 9 is a flow diagram of an LCD profile creation FIG. 10 is a flow diagram of the operation of a sub optimal delivery schedule instantiation algorithm;

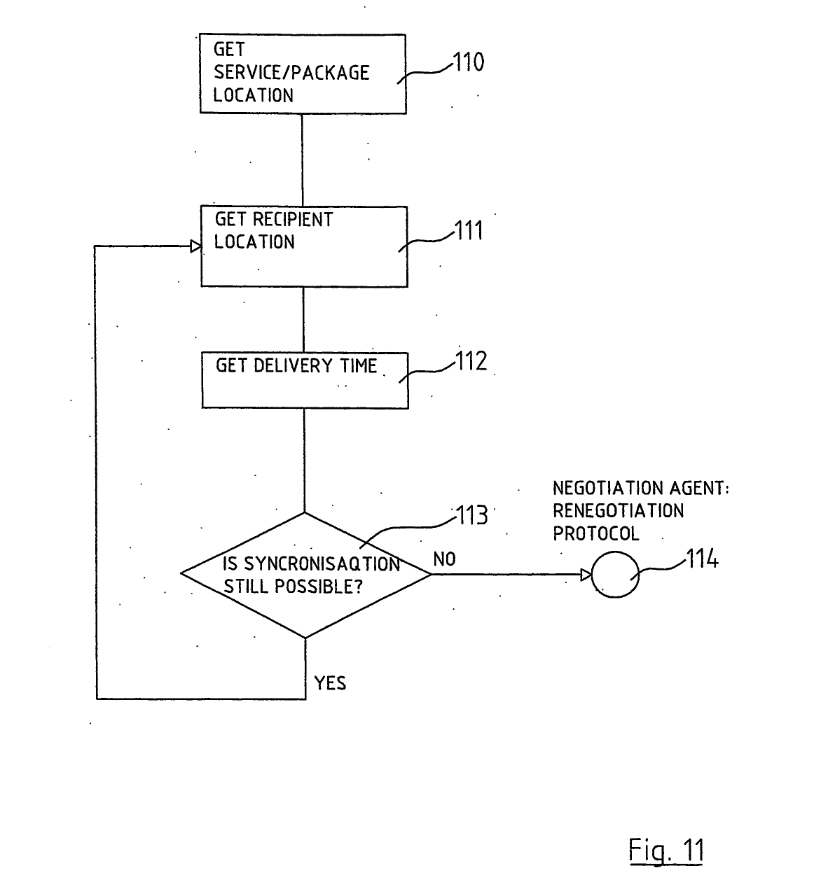

FIG. 11 is a flow diagram of the operation of the Delivery Sentinel; and

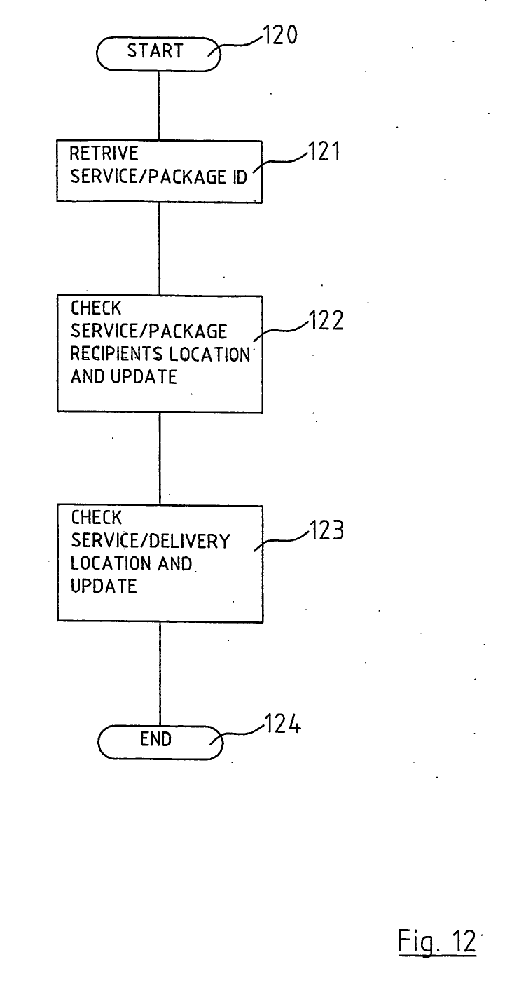

FIG. 12 is a flow diagram of the Service/Package Delivery Correlator in operation.

Referring now to the drawings and initially to FIGS. 1 and 2 thereof there is shown a system for scheduling delivery of goods, indicated generally by the reference numeral 1, comprising a logistics company depot (LCD) 2, a customer communications device 3 and a scheduling computer 4, all connected by way of a communications network (not shown). A logistics company 5 for managing access to the scheduling computer 4 by the LCD 2 and a system administrator 6 for maintaining the scheduling computer 4 are also provided.

The scheduling computer 4 further comprises a web server 7 connected to a core I/F logic engine 8. The core I/F logic engine 8 oversees the operation of the various component parts of the scheduling computer 4. The core I/F logic engine 8 is connected to an authenticator agent 9, a customer database 10, a database lookup agent 11, a scheduler agent 12, a profiler agent 13 and a biller agent 14.

The customer database 10 is further connected to the messaging gateway, shown here as SMS manager 15 further comprising an SMS sender 16 and SMS receiver 17. The customer database 10 additionally has access to an e-mail manager 18 connected to POP and SMTP server 19. The database lookup 11 is connected to a database 20 and can cause read/writes from the database 20. In addition to the forgoing, there is provided an auditor 21 to further monitor the operation of the scheduling computers 4 component parts and to track text messages that have not been sent correctly. Furthermore, there is provided a Delivery Sentinel 22 to monitor the position of the customer communication device relative to the delivery location at a predetermined time prior to the earliest delivery time and based on that information the Delivery Sentinel causes the SMS sender to send a message to the customer communication device 3 either confirming or canceling the delivery. A Service/Package Delivery Correlator (SPDC) 23 is provided to monitor the position of the package recipients location.

In use, a delivery request is made by the LCD 2 or LC 5 to the scheduling computer 4. For reasons of clarity in the following embodiment the term LCD will be used however it will be understood that instead of LCD 2 the steps could in fact be performed by the logistics company 5. The delivery request is rooted through the web server 7 to core I/F logic engine 8 of the scheduling computer 4. The core I/F logic engine 8 invokes the authenticator 9 to authenticate the access to the scheduling computer 4 by the LCD 2. If the delivery request comes from a valid LCD the scheduling computer calls the profiler 13 and scheduler 12 to determine the delivery preferences of that LCD sending the delivery request from the times still available for that LCD to deliver according to the profiler and scheduler respectfully. Once it has obtained the profile and schedule information from the profiler 13 and scheduler 12, the core I/F logic engine 8 invokes the customer database 10, the customer database 10 retrieves the mobile telephone number for the customer relating to the delivery request as well as the customer location and determines how the customer location fits in with the current LCD delivery schedule. The customer database then calls the SMS manager 15 and the SMS sender 16, which generates an SMS message to be sent to the customer communication device in accordance with the customer location and the LCD schedule and profile information already obtained. This SMS message is then sent to the customer communication device for review. An example of a typical generated message is shown below.

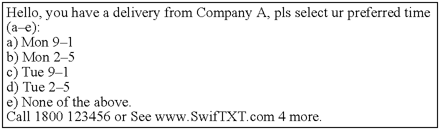

The customer operating the customer communication device 3 then specifies a response to the SMS text message and replies to the scheduling computer by way of an SMS test message response. An example of a typical SMS response is shown below.

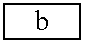

The SMS text message response, when received by scheduling computer is passed to the SMS receiver 17 where the response is translated in to computer readable format. The selected response is then used to update the schedule of the LCD in the scheduler 12. The new schedule may then be retrieved by the LCD 2 when required.

An example of a schedule displayed to the LCD is shown below.

| Date | Time | Delivery # | Address |
|---|---|---|---|
| Monday 10/9/2002 | 9-1 | D22322 | 95 Mt. Pleasant Avenue, |
| | | | Stillorgan |

If however, the response from the customer communication device 3 indicates that none of the suggested delivery options are suitable the SMS receiver 17 informs the customer database 10 via the SMS manager 15, the customer database then calls the scheduler 12 and profiler 13 again and determines the next time slots available for delivery by the LCD. The customer database then causes the SMS sender to generate and send an SMS text message to the customer 3 with the next available delivery times. If a positive response is returned by the customer database then the scheduler 12 is updated in the manner already described.

Once the scheduler has been sent the Biller 14 is updated with the data relating to the last SMS text message sent. Any additional data may be stored in database 20 by way of database lookup 11. At a predetermined initial time, prior to the earliest estimated delivery time the Delivery Sentinel 22 determines the geographic location of the customer communications device 3 and depending on the distance between the customer communications device and the delivery location invokes the SMS sender 16. The SMS sender sends an initial delivery text message to the customer communications device either canceling or confirming delivery. The Delivery Sentinel 22 further determines the geographic location of the package at a particular point in time and estimates whether the delivery can be completed as agreed. If not the Delivery Sentinel calls on the scheduler to reschedule the delivery. The SPDC 23 constantly monitors the location of the package recipient and the delivery location and updates an SPDC database (not shown) where information may be accessed and used by the Delivery Sentinel.

Referring now to FIG. 3 of the drawings there is shown an alternative block diagram of the system according to the invention. There is additionally provided an alternative route for flat file format transfer over e-mail, FTP or HTTP post indicated by the numeral 140 and further gateways 150 throughput of data.

Referring now to FIG. 4 of the drawings there is shown a flow diagram outlining the method of the invention. In step 24 the logistics company's representative registers the logistic company depot with the system. A password and a user ID for that LCD are agreed between the system administrator and the delivery company depot representative to allow use of the system by the LCD. In step 25 the LCD creates a delivery profile that specifies the times and days in which it will be able to perform deliveries to customers together with the details of the trucks making the delivery. It is understood that steps 24 and 25 need only be carried out once on setup and thereafter the LCD will be able to access the system and its profiles stored thereon by logging into the system directly. In step 26 the LCD logs on to the scheduling computer using the username and password obtained at registration. In step 27 the username and password are authenticated by the authenticator 9. If the password and username are not valid the method returns the user to logon, step 26. If however, the username and password are valid the user is forwarded to an options menu such as that shown in the table below.

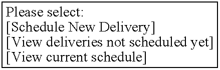

From that menu the LCD may select any of the options, which include scheduling a new delivery. In order to do this the LCD enters a barcode and sends the barcode to the scheduling computer 4 in step 28. Alternatively, after scanning in a barcode, the data relating to the barcode is written to a flat file and the flat file is transmitted to the scheduling computer in an appropriate format.

On receiving a delivery request from the LCD 2 or LC 5, the scheduling computer accesses the profiler 13 in step 29 and retrieves the profile information relating to that LCD or LC 5. The scheduling computer 14, in step 30 then accesses the scheduler 12 and retrieves the schedule information relating to the LCD 2 or LC 5 making the delivery request. In step 31, the scheduling computer retrieves the number of the customer communication device 3 from database 20 via database lookup 11.

The scheduling computer 4 then generates an SMS text message to be sent to the customer communication device 3 according to the delivery request and the profile and schedule information in step 32. In step 33 the scheduling computer sends the SMS to the customer communication device 2. The customer communication device 2 operator reviews the SMS text message sent to it and responds to the text message in the manner described above. In step 34 the scheduling computer 4 receives the response from the customer communication device in SMS text message format. The SMS receiver 17 processes the SMS text message response in step 35. If the response is positive i.e. one of the selected time slots for delivery has been accepted by the customer and that choice returned to the scheduling computer 4 in the text message response, the method proceeds to step 36. If however, the response to the SMS text message is negative i.e. none of the suggested delivery times was acceptable and the response indicates that the times are unacceptable, then the method returns to step 29 where the scheduling computer begins the process of generating a further SMS text message to be sent to the customer communication device 3 with further delivery time options.

In step 36, once a positive response has been obtained from the customer communication device 3 the scheduling computer updates the schedule for that LCD/LC. In step 37 the database 20 is updated with any additional information such as the contact details or preferences of a particular customer and in step 38 the Biller is updated to incorporate the billing for the latest delivery request made by the LCD 2/LC 5. Subsequently, in step 39 the scheduling computer 4 transmits the updated schedule to the LCD 2 or LC 5 as the case may be.

Then in step 40 at a predetermined initial time prior to the earliest estimated delivery time, the SPDC determines the geographic location of the customer communications device. This is determined using a hybrid of cellular and/or satellite based localisation technologies, for example in this case GSM and GPS technologies. The geographic location of the customer communication device is determined using either GSM or GPS depending on the location of the customer communication device. GPS will normally be the preferred option in rural areas whereas GSM would be desirable in urban areas but a combination of both is envisaged to increase reliability and accuracy. In step 41 the distance between the customer communications device and the agreed delivery location is calculated and in step 42 the scheduling computer generates an SMS message either canceling or confirming the delivery of goods based on the distance calculated in step 41.

Referring now to FIG. 5 of the drawings there is shown a flow diagram of the negotiation process between the LCD, the scheduling computer and the customer communication device to arrange a suitable delivery time. In step 51, the LCD sends a delivery request to the scheduling computer. In step 52 the scheduling computer checks the delivery schedule for that LCD and calculates the available time slots. In step 53 the scheduling computer sends a text message to the customer communications device with the available time slots for delivery. In step 54 the customer either accepts or refuses the proposed delivery time by notifying the scheduling computer in a text message sent from the customer communications device. If the customer refuses the proposed delivery times a further available set of delivery times is calculated in step 55 before these times are re-presented to the customer communication device in step 53 once again. If however the customer accepts one of the time slots at step 54 the scheduling computer updates the delivery schedule of the LCD in the scheduling database. The scheduling updating is then complete in step 57. If at step 54 the user decides to cancel delivery the process is automatically terminated and proceeds to step 57.

Referring now to FIG. 6 of the drawings there is shown a flow diagram of the steps taken for a user to renegotiate a package delivery. The user may decide that they can no longer meet the delivery criteria previously agreed and at step 61 the user through their customer communication device informs the scheduling computer that it wishes to cancel the delivery. In step 62 the scheduling computer then ascertains the location of the delivery provider. There are essentially three distinct situations that may arise when a user requests rescheduling of the delivery, namely, they wish the time of delivery to be changed, they wish the destination of the delivery to be changed and finally they wish both the time and destination of the delivery to be changed. A charge may be applied to a non-delivery due to user initiated delivery cancellation.

Change of Time:

If the user simply wishes to change the time of the delivery the process proceeds to step 63 where the scheduling computer recalculates the available time slots for delivery to the customer at that location. Once the available time slots have been calculated the method proceeds to step 67 where delivery negotiation between the scheduling computer and the customer communication device is carried out

Change of Destination:

If however, at step 62, the customer communication device, instead of wishing to renegotiate a delivery time, wishes to change the destination of the delivery the method proceeds to step 64 where the scheduling computer locates the user and then calculates the available time slots for delivery to the user in that location in step 65. This entails checking the time of day, the pre-existing schedule and the proximity of the new location to the future scheduled drop-offs. Once the available time slots have been calculated the method proceeds to step 67 where the normal negotiation protocol between the user and the scheduling computer is carried out.

Change of Time and Destination:

Finally, if the user wishes to change the destination and the time of service changes at step 62, the method proceeds directly to step 66 where the user is queried as to the new destination in which they wish the delivery to take place. In step 68 the user then requests the available time slots from the scheduling computer. The method then proceeds once again to step 67 where basic negotiation is carried out between the customer communication device and the scheduling computer. The scheduling computer will check the pre-existing schedule and proximity to future scheduled drop-offs before transmitting available delivery times to the user.

Referring to FIG. 7 of the drawings where there is shown a flow diagram of an LCD canceling the delivery of goods. In step 71 the LCD informs the scheduling computer that it wishes to cancel the delivery of the goods. In step 72 the scheduling computer informs the user of the cancellation. In step 73 the user is polled whether they wish to agree to the rescheduling of the delivery. If at step 73 the user declines the rescheduling of the goods a refund to the client is made in step 74. If however, the user agrees to the rescheduling the method proceeds to step 75 where the scheduling computer interrogates the LCD in an attempt to ascertain when the delivery of goods can be made. Based on the response from the LCD the scheduling computer in step 76 recalculates available time slots for delivery. Then in step 77 the scheduling computer proceeds with the basic negotiation protocol between the user and the LCD and the client is billed for the renegotiation.

Referring to FIG. 8 of the drawings there is shown a flow diagram of the method of billing a customer having a customer communications device. In step 80 a customer has requested that a delivery be made using the scheduling computer to negotiate the delivery of the goods or that the times suggested by the LCD attempting to renegotiate a delivery are not suitable to them. In step 81 the mobile telephone number of the customer communications device as well as the amount required for the service is provided to the biller 14. In step 82 a check is made of the scheduling computers memory to ascertain whether the mobile number is currently in the database. If the mobile number is in the database the method proceeds to step 83 where the credit card details of the customer are retrieved from scheduling computers memory and in step 84 a payment request or refund request is processed through the credit card merchant (not shown). Once the request has been processed the method proceeds to step 85 where the transaction is added to the billing database whereafter billing reports may be generated in step 86 if desired. Customised bills are generated for the LC based on the LCD profile. The customisation may involve the frequency and detail/format of the bills. If at step 82 the mobile number is not on the database the method proceeds directly to step 88 where the transaction is processed. In step 89 the type of transaction whether it is a debit or a credit of a customer account is ascertained and if the transaction is a debit type transaction the method proceeds to step 90 where cost details are supplied to the user and the user is charged accordingly. These same cost details and charges are also supplied to the telecommunications billing system of that mobile phone number and the charge is added directly onto their mobile phone bill. If however the transaction type is a credit the method proceeds to step 91 where refund details and refunds are supplied to the user and to the telecommunications billing system. Once either the cost details or the refund details have been supplied the method proceeds to step 85 where the transactions is added to the billing database. The method thereafter may proceed to step 86 to generate a billing report.

Referring now to FIG. 9 of the drawings there is shown a flow diagram of a logistics company profile being altered. In step 90 a logistics company manager accesses the system and in step 91 the scheduling computer determines whether or not the logistics company manager accessing the system is from a new or existing logistics company. If the logistics company manager is from a new company the method proceeds to step 92 where the initial profile for that company is set up to include inter alia, delivery schedules, number of drivers, towns in a particular area and the like which are stored in a logistics company profile database. Once the profile has been created the logistics company manager logs out in step 93. If however at step 91 the logistics company manager is not from a new logistics company and it is determined that the logistics company is a pre-existing company the method proceeds to step 94 whereafter the profile of the logistics company is retrieved from” memory. In step 95 the logistics company manager may update the logistics company profile. This is useful in that if the logistics company should take on a larger fleet of vehicles and increase it's capacity for deliveries this can be accounted for in the system. Not only the number of vehicles may change but also may the type of vehicle change to ones having a greater capacity. In addition to this the operating hours of the company may change over time which must be reflected in it's company profile. The new logistics company profile is stored in the logistics company profile database. Once the logistics company profile has been completed the profile manager may log out in step 93.

Referring now to FIG. 10 of the drawings there is shown a flow diagram of the operation of the sub-optimal instantiation algorithm. In step 100 the scheduling computer identifies the deliveries for a particular logistics company. In step 101 the scheduling computer accesses the logistic company profile database and identifies all the available slots as well as the capacity of the logistic company. In step 102 the scheduling computer populates those slots in a sub-optimal manner thereby creating a daily delivery schedule. In step 103 the scheduling computer will format the logistics company daily schedule. In step 104 a report of the logistics company daily schedule is printed by the scheduling computer. Thereafter in step 105 the daily schedule will be transmitted to the logistics company.

Referring now to FIG. 11 of the drawings there is shown a flow diagram of the delivery sentinel in operation. In step 110 the delivery sentinel ascertains the package location by requesting the information from the SPDC (not shown). In step 111 the delivery sentinel determines the recipients location at that particular time. In step 112 the scheduling computer looks up the daily delivery schedule for the logistics company and ascertains the projected delivery time for that package. In step 113 the scheduling computer determines whether synchronisation is still possible. If it is determined that synchronisation is not possible then the method proceeds to step 114 whereafter renegotiation of delivery times is carried out. If however at step 113 synchronisation is still possible the method will revert to step 110 to monitor the progress of the package and if it will still be delivered on time.

Referring now to FIG. 12 of the drawings there is shown a flow diagram of the service/package delivery correlator (SPDC) in operation. In step 120 the SPDC is called upon by the scheduling computer to monitor a particular delivery. In step 121 the SPDC retrieves the service/package ID. In step 122 the SPDC checks the customers location and updates the SPDC database. In step 123 the SPDC checks the service/delivery location and updates the SPDC database. A check is then made to see whether the recipient is likely to be at the correct location at the allotted time before a text message is sent either confirming or canceling the delivery of the goods. Whether the recipient is likely to be at the correct location at the allotted time is determined taking into consideration various factors such as traffic volumes, weather, time of day and the like. This monitoring procedure is carried out continuously until at step 124 the package delivery is finally made or cancelled and the process ends.

Of course, it will be understood that the delivery computer may not have the number of the customer communication device 2 already stored in memory 20. Indeed, the contact number may be retrieved from the LCD 2 or the LC 5 by opening up a communication channel between the LCD 2 or LC 5 and the scheduling computer 4. Indeed, the contact number of the customer communication device could be transmitted along with the delivery request by the LCD 2 or LC 5.

In the example described, the scheduling computer 4 communicates with the customer communication device 3 by way of SMS text messages. This is seen as particularly preferred as a cost efficient and simple way of communicating with the customer devices. However numerous other technologies could be incorporated into the invention.

The customer communication device 3 could be a mobile phone or any other such device capable of sending and receiving SMS text messages. What is important is that a short text message may be received and acknowledged in as simple a way as possible. As an alternative to SMS text messages, the scheduling computer 4 could generate an e-mail that could be sent to the customers communication device that could be a personal computer or a WAP enabled mobile telephone. The customer communication device operator could then reply to the e-mail with another e-mail or by SMS text message if desired. Alternatively the communication between the customer and the scheduling computer could be by way of dynamic interactive web pages or MMS messages.

Communication between the LCD, LC and the Scheduling computer is preferably conducted by way of SOAP messaging over HTTP or HTTP/s. This is a simple and cost effective way of transferring data between the LCD and the Scheduling computer. Files between the scheduling computer and the LCD could be transmitted using e-mail, FTP or HTTP post. The LCD could be provided with a standard off-the-shelf daemon that will handle file transfer from the directories in the LCD's file system. Also, in this way, access to the scheduling computer by the LCD could be by way of a simple browser used in the known manner.

To provide the simplest possible levels of integration the scheduling computer allows the use of a well defined flat file format to communicate with the scheduling computer over widely available messaging protocols such as e-mail and the like.

Another feature of the invention is that the LC or the LCD may register the LCD with the system. Once the LCD has been registered the LCD 2 will have the option of altering its profile. This is seen as convenient as the LCD 2 may change the profile to accommodate for staff shortages, industrial action, vehicle shortage, public holidays, change in company policy or the like that would effect the times when the company would be able to deliver the packages.

Another feature of the invention would be that if the customer rejected the suggested delivery times sent by the scheduling computer the scheduling computer would suggest the customer to collect the package from the depot directly themselves. Alternatively, the customer could be prompted to suggest a delivery time and date which could then be checked for suitability by the scheduling computer in accordance with the profile and schedule of the LCD and either accepted or rejected by the scheduling computer. A suitable response message from the scheduling computer 4 could be generated.

What must also be understood is that the scheduling computer may be implemented largely in software. Therefore, the invention also extends to computer programs, particularly computer programs on or in a carrier, adapted for putting the invention into practice. The program may be in the form of source code, object code or code intermediate source and object code. The program may be stored on a carrier such as any known computer readable medium such as a floppy disk, ROM, CD-ROM or DVD. The carrier may be a transmissible carrier such as an electrical or optical signal, which may be conveyed via electrical or optical cable or by radio or other means. When the program is embodied on a signal, which may be conveyed directly by a cable or other device, the carrier may be constituted by such a cable or other device means.

The Scheduling computer is implemented on top of the Microsoft.NET® framework. All programmatic interaction between the LCDs back end systems and the scheduling computer takes place over web services. These include industry standard SOAP/XML web services. This is seen as particularly preferred as web services allow for a high degree of interoperability between new and legacy systems as well as the widespread use across the web. Instead of using web services the interaction between the LCDs back end systems and the scheduling computer could take place via e-mail.

The interface with the customer is via a message gateway. The gateway uses a well-defined internal interface to communicate with the Scheduling computer, allowing the Scheduling computer to be independent of the messaging protocol. At present SMS has been chosen as the messaging protocol as it currently has the widest application. It is envisaged that other messaging protocols may be used as technology develops.

In essence, all that the Scheduling computer requires from the delivery company depot is some form of package ID and the contact details of the customer. The Scheduling computer will then return the same package ID along with the customers preferred delivery time to the delivery company depot. This information, for example, is taken from the delivery company database by periodic exports to a flat file where a simple application can read the file and call the web service to initiate communication with the Scheduling computer.

Further developments to the system involve the integration of both cellular triangulation and GPS (Global Positioning System) to give real time location information to the routing algorithms. This information could relate to the position of the customer or the delivery van which may be sent to the other party to alert them of the whereabouts of the other party. This may be particularly useful to the logistics company as they could determine whether the customer is ‘at home’ as well as using the information to determine routing and direction information. The use of either GPS or GSM triangulation (phone cell system) will be determined by the geographic location of the device being tracked. For instance GPS may be preferable when tracking a device in the countryside or more rural areas whereas GSM triangulation will be highly effective in urban areas.

Another feature of the invention is to instantly bill recipients of packages/services because of some delivery feature that they have requested or require before receiving the package or service. Billing is done by using the recipients communication device unique identifier. In the case of a mobile phone, this will be their mobile phone number. It is achieved by sending a message through their telecommunication's provider where the message's destination address is the recipients address/identifier and the source address of the message indicates the amount to bill the recipient. By aggregation of the Delivery Sentinel and the billing mechanism it is possible to provide a premium delivery service where recipients can request to be billed for receiving the package or service. This could be used to provide an out-of-hours delivery service, or delivery where additional premiums must be paid. The billing of a customer account could be achieved by billing through the deduction of the communications network provider of the customer account or it could be via deduction from a credit card account held by the customer that is billed. In many instances it will be the user and not the LCD that is charged for the delivery. This may be because there are import duties due or VAT payments due on the purchases. It is envisaged that the change may in fact be split between both the LCD and the customer with the LCD paying for the service and the customer paying any duties owed.

Another feature of the invention allows for brand-able messages. This is controlled through the logistics company's profiles and allows the insertion of arbitrary graphical or textual content into the message sent to the recipient. Although the invention has been described in terms of “text” messages it will be understood that the message may contain additional material other than text such as graphical images.

It will be further understood that the method may be carried out across a distributed network in which certain parts of the network will be remote with respect to other parts of the network. These parts of the network that are remote may be not only physically separate but may be located in other jurisdictions.

In this specification the terms “comprise, comprises, comprised and comprising” as well as the terms “include, includes, included and including” are deemed totally interchangeable and should be afforded the widest possible interpretation.

This invention is not limited to the embodiments hereinbefore described but may be varied in both construction and detail.

1-57. (canceled)

58. A method of scheduling delivery of goods from a logistics company depot (LCD) to a customer having an associated customer account and a customer communications device capable of receiving and transmitting a text message in a system comprising a scheduling computer having scheduling memory and a communications network including a network computer holding the customer account, in which the method comprises the steps of:
(a) a delivery request being sent to the scheduling computer;
(b) the scheduling computer generating a text message according to the delivery request;
(c) transmitting the text message to the customer communications device requesting confirmation or otherwise of acceptance of proposed delivery at a designated delivery location;
(d) receiving a response to the text message from the customer communications device;
(e) updating scheduling information for the LCD according to the response from the customer communications device and sending the scheduling information to the LCD and the customer communications device by a further confirmation text message giving delivery details including earliest estimated delivery time; and
(f) at a pre-determined initial time, prior to the earliest estimated delivery time, the geographic location of the customer communications device is determined and depending on the distance between the customer communications device and the delivery location an initial delivery text message is sent, canceling or confirming the delivery.

59. The method of scheduling delivery of goods as claimed in claim 58, in which when the text message is sent, the cancellation or confirmation of the delivery will be carried out at a predetermined future time, unless a text message from the customer communications device is received prior to that time to cause the decision regarding the delivery to be cancelled.

60. The method of scheduling delivery of goods as claimed in claim 58 in which after the delivery has commenced and at a predetermined time prior to the estimated delivery time, a final delivery text message is sent to the customer communications device.

61. The method of scheduling delivery of goods as claimed in claim 58, in which, for the LCD, there is stored by the scheduling computer, delivery rules established by the LCD detailing the conditions under which the delivery will be handled.

62. The method of scheduling delivery of goods as claimed in claim 58, in which:
when the system includes a customer account associated with a customer and the method requires the payment of money, the customer communications device is sent a text message detailing the debiting or crediting required of the customer account;
the customer communications device sends a text message confirming permission to debit or credit the account with sufficient details to allow the action take place; and
the LCD carries out the necessary action in respect of the account.

63. The method of scheduling delivery of goods as claimed in claim 62, in which the customer communications device confirms the permission directly to the network computer.

64. The method of scheduling delivery of goods as claimed in claim 58, in which when, prior to delivery, the customer communications device sends a text message to the scheduling computer altering the proposed delivery details, the scheduling computer cancels the delivery and carries out the method as if it were a new delivery.

65. The method of scheduling delivery of goods as claimed in claim 58, in which on the initial delivery text message being sent canceling the delivery, the method further comprises the step of the scheduling computer generating a further text message to reschedule the delivery.

66. The method of scheduling delivery of goods as claimed in claim 58 in which the geographic location of a logistics company parcel service provider is monitored and depending on the distance between the parcel service provider and the delivery location an initial delivery text message is sent, canceling or confirming the delivery.

67. The method of scheduling delivery of goods as claimed in claim 58 in which on the logistics company determining that they cannot deliver the goods at the agreed time and location, the logistics company sends a reschedule request to the customer via the scheduling computer.

68. The method of scheduling delivery of goods as claimed in claim 58 in which on the geographic location of the customer communications device being determined a rescheduling request is sent to at least one of the customer communications device and the LCD.

69. The method of scheduling delivery of goods as claimed in claim 66, in which the geographical location of both the customer communication device and the parcel service provider are monitored and on the distance between the customer communication device and the parcel service provider being below a predetermined distance a rescheduling request is sent to at least one of the customer communication device and the parcel service provider.

70. The method of scheduling delivery of goods as claimed in claim 58 in which the geographic location of the customer communications device is determined using either GPS, the phone cell system or a combination of the GPS and phone cell system dependant on the geographic location of the customer communications device.

71. The method of scheduling delivery of goods as claimed in claim 58 in which the step of generating a text message according to the delivery request further comprises generating a short message service (SMS) text message.

72. The method of scheduling delivery of goods as claimed in claim 58 in which the step of receiving a response to the text message further comprises receiving an SMS text message from the customer communication device.

73. The method of scheduling delivery of goods as claimed in claim 58 in which the step of generating a text message according to the delivery request further comprises generating an MMS message.

74. The method of scheduling delivery of goods as claimed in claim 58 in which the step of generating a text message according to the delivery request further comprises retrieving LCD scheduling information from the scheduling memory and generating the text message according to the scheduling information.

75. The method of scheduling delivery of goods as claimed in claim 58 in which the step of generating a text message according to the delivery request further comprises retrieving LCD profile data containing the suitable and available delivery times available to the LCD to make the delivery from the scheduling memory and generating the text message according to the profile data.

76. The method of scheduling delivery of goods as claimed in claim 58 in which the scheduling computer sends the scheduling information to the LCD at predetermined intervals.

77. The method of scheduling delivery of goods as claimed in claim 58 wherein the LCD requests the information from the scheduling computer when necessary.

78. The method of scheduling delivery of goods as claimed in claim 58 in which the scheduling computer stores a log of unsuccessfully sent text messages and re-sends those text messages after a predetermined time limit.

79. The method of scheduling delivery of goods as claimed in claim 58 in which the scheduling computer on receiving a response from the customer communication device that the proposed delivery times are unsuitable, the scheduling computer generates a further text message arranging the delivery of goods and sends the further text message to the customer communication device.

80. The method of scheduling delivery of goods as claimed in claim 58 in which subsequent to receiving the delivery request from the LCD the scheduling computer retrieves the contact details for the customers communication device from the LCD.

81. The method of scheduling delivery of goods as claimed in claim 58 in which on receiving a customer communication device contact details, the scheduling computer stores the details in the scheduling memory for future use.

82. The method of scheduling delivery of goods as claimed in claim 58 in which before retrieving the contact details from the LCD the scheduling computer attempts to retrieve the contact details from scheduling memory.

83. The method of scheduling delivery of goods as claimed in claim 58 in which the LCD sends a delivery request to the scheduling computer by sending a barcode to the scheduling computer.

84. The method of scheduling delivery of goods as claimed in claim 58 in which on completion of a delivery the LCD accesses the scheduling information and updates the scheduling information.

85. The method of scheduling delivery of goods as claimed in claim 58 in which the updated scheduling information is sent to the scheduling computer and the scheduling computer updates its scheduling information accordingly.

86. The method of scheduling delivery of goods as claimed in claim 58 in which the LCD updates its profile data in the profiler in accordance with its resources.

87. The method of scheduling delivery of goods as claimed in claim 58 in which in sending the response to the delivery request text message the customer communication device sends a suggested delivery time and the scheduling computer checks the suggested delivery time for suitability before responding to the customer communications device.

88. The method of scheduling delivery of goods as claimed in claim 58 in which on the customer suggesting a further delivery time and that delivery time being suitable, the scheduling computer updates the scheduling data.

89. The method of scheduling delivery of goods as claimed in claim 58 in which the method further comprises the steps of the scheduling computer generating a sub-optimal schedule for the logistics company depot and transmitting the sub-optimal schedule to the logistics company depot.

90. The method of scheduling delivery of goods as claimed in claim 58 in which the method further comprises the step of the scheduling computer generating a customised report for the LCD.

91. The method of scheduling delivery of goods as claimed in claim 58 in which at a predetermined time the scheduling computer transmits billing data to a customer communications device's network operator.

92. The method of scheduling delivery of goods as claimed in claim 58 in which the step of generating a text message according to a delivery request further comprises inserting LC specific graphical or textual content into the message.

93. A method of scheduling delivery of goods from a remote logistics company depot (LCD) to a customer having an associated customer account and a customer communications device being capable of receiving and transmitting a text message in a system comprising a remote scheduling computer having scheduling memory and a communications network including a network computer holding the customer account, in which the method comprises the steps of:
(a) the customer communications device receiving a text message from the remote scheduling computer requesting confirmation or otherwise of acceptance of proposed delivery at a designated delivery location;
(b) transmitting a response to the text message from the customer communications device to the remote scheduling computer; and
(c) at a predetermined initial time prior to the earliest estimated delivery time, the customer communications device receives an initial delivery text message canceling or confirming the delivery, the content of the delivery text message being dependent on the relative position of the customer communications device to the designated delivery location.

94. The method of scheduling delivery of goods as claimed in claim 93 in which a further delivery text message is received at a predetermined future time after the initial text message was received unless a text message is sent from the customer communications device to the remote scheduling computer prior to the predetermined future time to cause the decision regarding the delivery to be cancelled.

95. The method of scheduling delivery of goods as claimed in claim 93 in which after the delivery has commenced and at a predetermined time prior to the estimated delivery time, a final delivery text message is received by the customer communications device.

96. The method of scheduling delivery of goods as claimed in claim 93 in which the customer communications device receives a text message detailing the debiting or crediting required of a customer account, the customer communications device sends a text message confirming permission to debit or credit the account with sufficient details to allow the action to take place.

97. The method of scheduling delivery of goods as claimed in claim 96 in which the customer communications device sends the text message confirming permission to the remote LCD.

98. The method of scheduling delivery of goods as claimed in claim 96 in which the customer communications device sends the text message confirming permission directly to the network computer.

99. The method of scheduling delivery of goods as claimed in claim 93 in which having received a further delivery text message canceling the delivery, the customer communications device receives a further text message rescheduling delivery.

100. The method of scheduling delivery of goods as claimed in claim 93 in which on the distance between the customer communications device and the parcel service provider being below a certain predetermined distance a rescheduling request is received by the customer communications device.

101. A method of scheduling delivery of goods from a Logistics Company Depot (LCD) to a remote customer having an associated customer account and a customer communications device being capable of receiving and transmitting a text message in a system comprising a remote scheduling computer having scheduling memory and a communications network including a remote network computer holding the customer account in which the method comprises the steps of:
(a) transmitting a delivery request from the LCD to the remote scheduling computer;
(b) receiving scheduling information from the remote scheduling computer detailing a delivery to be made from the LCD including earliest estimated delivery time for that delivery; and
(c) at a predetermined initial time, prior to the earliest estimated delivery time, an initial delivery text message, either canceling or confirming the delivery dependent on the proximity of the remote customer communications device to the delivery location, is received by the LCD.

102. The method of scheduling delivery of goods as claimed in claim 101 in which on receipt of the initial delivery text message canceling the delivery the LCD sends a further delivery request to the remote scheduling computer.

103. The method of scheduling delivery of goods as claimed in claim 101 in which the method further comprises the initial step of the LCD establishing delivery rules detailing the conditions under which the delivery will be handled.

104. The method of scheduling delivery of goods as claimed in claim 101 in which the LCD transmits a payment request to the remote customer communications device and thereafter the LCD receives payment information from the remote customer communications device and carries out the necessary action in respect of the account.

105. The method of scheduling delivery of goods as claimed in claim 101 in which on the logistics company depot determining that they cannot deliver the goods at the agreed time and location, the logistics company depot sends a reschedule request to the remote customer communications device via the remote scheduling computer.

106. The method of scheduling delivery of goods as claimed in claim 101 in which on the distance between a LCD personnel and the customer communications device being below a predetermined distance, a rescheduling request is received by the LCD personnel

107. The method of scheduling delivery of goods as claimed in claim 101 in which the distance between the LCD personnel and the delivery location is monitored and depending on the distance between the delivery location and the LCD personnel at that point in time, a text message is received by the LCD canceling or confirming delivery.

108. The method of scheduling delivery of goods as claimed in claim 101 in which the method further comprises the step of the LCD receiving a sub-optimal schedule from the remote scheduling computer.
